(19) United States
(12) Patent Application Publication
(10) Pub. No.: US 2026/0066817 A1
(43) Pub. Date: Mar. 5, 2026

(54) METHOD FOR DE-EXCITING A ROTOR OF AN ELECTRIC MACHINE, CONTROL DEVICE, ELECTRIC MACHINE AND MOTOR VEHICLE

(71) Applicant: AUDI AG, Ingolstadt (DE)

(72) Inventor: Daniel RUPPERT, Lenting (DE)

(21) Appl. No.: 19/311,985

(22) Filed: Aug. 27, 2025

(30) Foreign Application Priority Data
Aug. 28, 2024 (DE) 102024124569.7

(51) Int. Cl. H02P 3/12; B60R 16/023

(52) U.S. Cl. CPC H02P 3/12; B60R 16/0231

(57) ABSTRACT

A method for de-exciting rotor windings of a rotor of an electric machine for a motor vehicle, wherein the electric machine includes a stator and the rotor rotatably mounted with respect to the stator, wherein an active rectifier including at least one field effect transistor controllable by way of a control voltage is provided, wherein the active rectifier electrically connects a voltage source present on a part of the rotor to the rotor windings, wherein the at least one field effect transistor is brought into an operating state that de-excites the rotor windings by way of the control voltage, in which the at least one field effect transistor forms an ohmic resistance, and wherein an energy stored in the rotor windings brings about an electrical current flow through the at least one field effect transistor, and at least part of this energy is converted into thermal energy.

### BACKGROUND

### Technical Field

The present disclosure relates to a method for de-energizing rotor windings of a rotor of an electric machine of a motor vehicle, wherein the electric machine comprises a stator and the rotor rotatably mounted with respect to the stator and having the rotor windings for generating a rotor magnetic field.

### Description of the Related Art

Electric machines are often used as traction motors in motor vehicles, which can be purely electric vehicles or hybrid vehicles. Electric machines comprise a stator and a rotor rotatably mounted with respect to the stator, wherein windings consisting of a conductor wire and, if appropriate, permanent magnets are provided on the part of the stator and the rotor, wherein electromagnetic interactions between the magnetic fields generated by the windings and, if appropriate, the permanent magnets bring about the generation of a drive or braking torque. If there are no windings on the part of the rotor but only permanent magnets, the machine is also referred to as a permanently excited synchronous machine. If there are no permanent magnets on the part of the rotor but only windings, which are referred to as rotor windings, the machine is referred to as an externally excited synchronous machine. Externally excited synchronous machines offer additional degrees of freedom in the context of the control and design of the electric machine.

One problem associated with externally excited synchronous machines is that in certain cases, or in the event of an error, particularly when a strong magnetic field is currently being generated by the rotor windings, high electrical currents or voltages are induced. These currents and voltages could damage electrical structural components or semiconductor components. As a countermeasure, the rotor windings are de-excited, i.e., the magnetic fields present on the part of the rotor windings, i.e., the energy stored in the rotor windings, are/is reduced in a targeted manner and as rapid as possible. For this purpose, it is often provided that the energy stored in the rotor windings is dissipated, i.e., in particular, converted into thermal energy. Related concepts are known, for example, from DE 10 2009 040 394 A1, DE 10 2022 121 516 A1, and US 2013/0 193 903 A1.

### BRIEF SUMMARY

The present disclosure is based on the object to provide an advantageous concept with respect to the de-excitation of rotor windings of a rotor of an electric machine, in particular with regard to the simplest and least costly implementation possible.

According to the disclosure, the object is achieved in a method of the type mentioned above in that an active rectifier comprising at least one field effect transistor controllable by way of a control voltage is provided on the part of the rotor, wherein the rectifier electrically connects a voltage source present on the part of the rotor to the rotor windings, and an alternating voltage provided by the voltage source can be converted into a direct voltage by way of the rectifier, wherein the field effect transistor or at least one of the field effect transistors is brought into an operating state for de-exciting the rotor windings by way of the control voltage, in which operating state the respective field effect transistor forms an ohmic resistance, wherein an energy stored in the rotor windings brings about an electrical current flow through the at least one field effect transistor forming the ohmic resistance, so that at least part of this energy is converted into thermal energy.

The disclosure is based in particular on the idea that the rectifier, in addition to its actual function of rectifying an electrical voltage, is given a further function, namely to function as a way for converting energy stored in the rotor windings as soon as de-excitation, in particular rapid de-excitation, of the rotor windings is to take place. De-excitation is understood to mean a process in which the energy present on the part of the rotor windings, which is present or stored in the context of the electromagnetic field generated by the rotor windings, is removed from the rotor windings. In the context of the present disclosure, this energy is dissipated, i.e., converted into thermal energy. Since a component that is typically present anyway, namely the rectifier, is utilized for this purpose, no further structural components specifically provided for this purpose are required, which contributes to simplicity, the lowest possible manufacturing effort and the lowest possible overall weight of the electric machine.

The rotor is rotatably mounted with respect to the stator, which typically has stator windings for generating a stator magnetic field. For this purpose, a rotor shaft can be mounted via appropriate bearings, such as ball or roller bearings. The rotor and the stator are preferably arranged within a housing of the electric machine, with the stator preferably being arranged stationary relative to the housing. The housing is, in an assembled state, firmly connected to a body of the motor vehicle.

The rotor windings and/or the stator windings have at least one electrically conductive wire wound, for example, around rotor or stator teeth. The windings each function as a field coil that generates a magnetic field, i.e., the rotor or the stator magnetic field, when electrically energized.

The rectifier is understood to mean in particular an electrical structural component that comprises the at least one field effect transistor, typically a plurality of field effect transistors. Thus, the rectifier or at least the at least one field effect transistor can be controlled by way of the control signals, wherein the control signals can be directed to controlling the operation of the rectifier, such as the function of a rectifier and, if appropriate, an inverter. In contrast to active rectifiers, passive rectifiers typically only have semiconductor diodes, so that an alternating voltage applied to an input of the rectifier is always converted into a direct voltage at an output of the rectifier, independently of the control signals. According to the disclosure, however, an active rectifier is provided.

With respect to the field effect transistor, which can also be referred to as an FET transistor, it is conceivable that the field effect transistor or at least one of the field effect transistors is a metal oxide semiconductor field effect transistor. In this case, the field effect transistor can also be referred to as a MOSFET transistor. It is conceivable that the control signals are applied to the respective field effect transistor as a gate-source voltage, with a current flow being regulated with respect to a source-drain voltage as a function of the gate-source voltage. If the field effect transistor implements the ohmic resistance, this source-drain voltage is accompanied by a power loss causing the dissipation of the electrical energy stored in the rotor windings. The corresponding operating state of the field effect transistor can also be referred to as a linear operating state. In this state, the field effect transistor has a constant resistance and behaves like a voltage-controlled resistance whose resistance value is determined by the gate-source voltage.

With respect to the metal oxide semiconductor field effect transistor, a plurality of operating states can be induced in a targeted manner as a function of the control signals or the gate-source voltage. Here, with appropriate gate-source voltage values, the metal oxide semiconductor field effect transistor functions as a switch with respect to the source-drain current flow, with these operating states being set in a targeted manner in the context of the rectification by way of the control signals. Another operating state, the occurrence of which depends on the gate-source voltage value, is also referred to as the aforementioned linear operating state, in which the metal oxide semiconductor field effect transistor functions as the ohmic resistance. The linear operating state is present when the gate-source voltage is greater than a threshold voltage, which is defined as the gate-source voltage value at which a source-drain current flows for the first time. Furthermore, the linear operating state can be present if the source-drain voltage is also lower than the gate-source voltage. The linear operating state is normally avoided during normal operation of the electric machine, as this state is associated with the risk of metal oxide semiconductor field effect transistor burn-out. Within the context of the present disclosure, however, the control signals are generated in a targeted manner in such a way that the metal oxide semiconductor field effect transistor assumes precisely this operating state in the context of the de-excitation of the stator windings, with the electrical properties of the metal oxide semiconductor field effect transistor occurring in this case being utilized in a targeted manner to dissipate the energy present on the part of the rotor windings.

With respect to the rectifier, it is preferably provided that it comprises at least one circuit board, in particular having electrically conductive conductor tracks, and the at least one field effect transistor arranged thereon. The circuit board is understood to mean a printed circuit board on which the semiconductor components are arranged. The circuit board may consist of plastic. The semiconductor structural components may be attached to the circuit board by way of soldering and/or press-fit connections. The circuit board preferably has a flat, in particular planar, extension that can extend parallel to an outer surface of the cooling section that carries the circuit board in order to implement the most effective thermal connection possible.

It is conceivable that the field effect transistor or at least one of the field effect transistors is brought into the operating state for de-exciting the rotor windings by way of the control voltage, in which operating state the respective field effect transistor forms the ohmic resistance having a predetermined resistance value. In the context of this embodiment, the control voltage is generated not only in such a way that the field effect transistor is operated in the linear operating state at any given point. Instead, targeted control in this regard ensures that the field effect transistor has a resistance value, which is predetermined in a targeted manner. This resistance value can be chosen such that, on the one hand, the energy stored in the rotor windings is dissipated sufficiently efficiently, but, on the other hand, the field effect transistor does not heat up to such an extent that it could be damaged or burn out.

Particularly preferably, it is provided that when bringing the respective field effect transistor into the operating state in which this field effect transistor forms the ohmic resistance having a predetermined resistance value, a temperature dependence of the resistance value is taken into account. Here, in the linear operating state, the values of the resistance implemented by the field effect transistor depend not only on the gate-source voltage, but also on the current temperature of the field effect transistor. Thus, this temperature dependence represents a further control basis with respect to the generation of the control voltage. Thus, in the linear operating range, metal oxide semiconductor field effect transistors behave in such a way that the value of the ohmic resistance decreases with increasing temperature at a constant gate-source voltage, which could lead to field effect transistor burn-out.

Specifically, the temperature dependence can be taken into account by determining the current temperature of the respective field effect transistor. In the context of this embodiment, a specific result with respect to the determination of the temperature of the field effect transistor thus represents a control basis, so that the actual conditions with respect to the temperature of the field effect transistor can be incorporated into the corresponding control as realistically as possible. Avoiding burn-out can be avoided in the context of the present embodiment by reducing the gate-source voltage when the field effect transistor heats up in order to counteract or compensate for a temperature-related reduction in resistance.

The current temperature can be determined using measurement technology. For example, a temperature sensor can be provided in the region of the rectifier or the field effect transistor, by way of which measured values for the current local temperature can be generated. Additionally or alternatively, the current temperature can be determined using a model and/or a lookup table. Compared to determining the temperature by measurement technology, hardware components are saved in the context of this embodiment. By way of the model, dependencies of physical or electrical quantities for the field effect transistor can be determined according to its specific structural design. The results can also be saved and used as the lookup table.

In the context of the de-excitation of the rotor windings by way of the field effect transistor, excessive heat may develop around it, which may require targeted heat dissipation. To address this, it is conceivable that the field effect transistor or at least one of the field effect transistors is arranged on or in a cooling section of the rotor that forms a heat sink. According to this embodiment, a thermal coupling between the heat sink and the field effect transistor brings about or enhances dissipation of thermal energy from the field effect transistor. For this purpose, the field effect transistor is preferably in direct contact with the heat sink, preferably in a touch contact, apart from a heat-conducting medium that may be provided for fastening the field effect transistor, if appropriate.

In the context of a conceivable refinement, it is particularly preferably provided that the cooling section has at least one cooling channel through which a cooling fluid can flow. The cooling channel is understood to mean a cavity or hollow space of the rotor provided for guiding the cooling fluid. The cooling channel is preferably elongated, with the cooling fluid flowing through the cooling channel along its longitudinal direction. The rotor, which in particular consists of a metal, has an outer surface on which the field effect transistor can be positioned. The cooling channel preferably runs directly beneath the region of this outer surface in which the rectifier or the field effect transistor is arranged. The cooling fluid is preferably a cooling liquid, for example water or oil.

Particularly preferably, the cooling channel or at least one of the cooling channels is provided with a channel wall delimiting the cooling channel and having a deflection structure that deflects, in particular swirls, the fluid flowing along the channel wall. The deflection structure can be any geometric shape of the surface of the channel wall that is not a smooth or flat structure. The deflection structure can have bulges arranged on the inside of the cooling channel that protrude or project from the channel wall. The deflection structure can be provided, in particular only, in one section of the cooling channel that is located directly below the rectifier. The deflection structure brings about conversion of any laminar flow of the cooling fluid that may be present in the cooling channel into a turbulent flow, so that the transfer of heat to the cooling fluid is more effective. The deflection structure can have at least one cooling fin and/or at least one cooling rib. A cooling fin or a cooling rib is understood to mean, in particular, a web-like, elongated structure whose longitudinal direction extends along the channel wall. The longitudinal direction can be arranged perpendicularly or obliquely with respect to the flow direction of the cooling fluid, thereby increasing the deflection effect on the cooling fluid accordingly. The deflection structure can have a plurality of cooling fins or cooling ribs arranged one after the other with respect to the flow direction.

The circuit board or a circuit board of the rectifier can be attached to the cooling section. A heat-conducting medium can be arranged between the circuit board and the cooling section. A heat-conducting medium is understood to mean a material having a sufficiently high thermal conductivity coefficient to enable a most effective heat transfer possible from the rectifier to the cooling section. The thermal conductivity coefficient can have a value of at least 10 W/(m K). The heat-conducting medium is preferably a thermally conductive adhesive and thus, in addition to implementing the most effective heat transfer possible, is also used as a fastening means by which the rectifier is attached to the cooling section.

Additionally or alternatively, the circuit board can have a metal core. Due to the high thermal conductivity coefficient typically found in metals, heat transfer through the circuit board, which occurs in the context of the heat transfer from the at least one field effect transistor to the cooling fluid, is even more effective. This is advantageous, for example, when a support structure of the circuit board consists of a plastic, apart from the metal core and any conductor tracks present, if appropriate. The metal core may consist of aluminum and/or copper. The metal core is covered with a layer of plastic, in particular in the direction toward the field-effect transistor. The same generally applies to the direction toward the cooling section, wherein the metal core can also be exposed in this regard, so that there can be direct touch contact between the metal core and the cooling section, apart from any heat-conducting medium.

The electric machine preferably has an inductive rotary transformer, which comprises at least one rotor-side field coil present on the part of the rotor and forming the voltage source, and at least one stator-side field coil present on the part of the stator, wherein electrical energy can be transferred inductively from the stator-side field coil to the rotor-side field coil. The inductive rotary transformer enables contactless and therefore low-wear or wear-free power transfer from the stator to the rotor. The rotor-side field coil and the stator-side field coil move past each other during the rotation of the rotor, wherein magnetic fields generated on the part of the stator-side field coil bring about the occurrence of a voltage on the part of the rotor-side field coil by way of electromagnetic induction. The rotor-side field coil thus functions as the voltage source, with the generated voltage being present as an alternating voltage. This alternating voltage is converted into the direct voltage required for operation or for exciting the stator windings by way of the rectifier. Preferably, a plurality of field coils are provided which are arranged concentrically about an axis of rotation of the rotor and thus along the circumferential direction.

Although, according to the disclosure, de-excitation of the rotor windings by way of the field effect transistor that implements the ohmic resistance is provided, an alternative approach is conceivable as a possible further option in this regard, particularly under certain operating states of the electric machine or the motor vehicle. As an alternative to de-excitation of the rotor windings by way of the rectifier, a direct voltage present on the part of the rotor windings can be converted into an alternating voltage, wherein the energy stored in the rotor windings is inductively transferred from the rotor-side field coil to the stator-side field coil. For this purpose, by way of appropriately generated control voltages, the rectifier is brought into a state in which the direct voltage present on the part of the rotor windings is converted into an alternating voltage, which in turn is applied to the rotor-side field coil. Accordingly, power is dissipated to the stator-side field coil. In the context of this embodiment, a bidirectional transfer of power or energy is therefore possible by way of the rotary transformer and the rectifier.

It is conceivable that meeting a dissipation condition is checked, wherein the dissipation condition is only fulfilled or can be fulfilled if at least one piece of safety information is present which indicates the presence of an operating state of the electric machine and/or the motor vehicle in which transferring the energy from the rotor-side field coil to the stator-side field coil is disadvantageous. If the dissipation condition is not fulfilled, the de-excitation of the rotor windings can take place by way of the transfer of the energy stored in the rotor windings from the rotor-side field coil to the stator-side field coil and, if the dissipation condition is fulfilled, by way of converting the energy stored in the rotor windings into thermal energy by the at least one field effect transistor forming the ohmic resistance. The presence of the piece of safety information can imply that, if the energy is transferred from the rotor-side field coil to the stator-side field coil, damage to a component of the electric machine and/or the motor vehicle could occur. The piece of safety information may also indicate that this transfer could pose a danger to a user, for example due to exposed components under electrical voltage, which may be particularly the case in the event of an accident.

The piece of safety information or at least one of the pieces of safety information can indicate that a state of charge of an electrical energy storage device of the motor vehicle, which provides the electrical energy required to operate the electric machine, and possibly of an intermediate circuit capacitor of the electric machine, exceeds a predetermined limit value. For example, the energy transferred from the rotor-side field coil to the stator-side field coil is typically utilized to charge the electrical energy storage device, which is not possible if the latter has a correspondingly high state of charge. The predetermined limit value can be chosen such that it is exceeded when the electrical energy storage device is fully charged or no longer has any free storage capacity sufficient to absorb the transferred energy. The corresponding piece of safety information can be obtained from a piece of information available in the context of a vehicle control system regarding the current charging status of the electrical energy storage device. Additionally or alternatively, a determination of the charging status by measurement is conceivable. It is also conceivable that the piece of safety information or at least one of the pieces of safety information items indicates that an error condition exists on the part of a drive unit of the motor vehicle. This particularly applies to the previously mentioned case in which the motor vehicle had an accident. In this case, the piece of safety information can be generated if, for example, a control signal is present which triggers an airbag in the vehicle.

Furthermore, the present disclosure relates to a control device, in particular for a motor vehicle or an electric machine. According to the disclosure, the object is achieved with such a control device in that it has a computer-readable storage medium on which executable instructions are stored which, when executed by way of a processing device of the control device, cause the control device to carry out at least one of the steps of the method according to the preceding description. Thus, the control device is particularly set up to generate and output control signals for carrying out this method. These control signals can directly be the control voltage output to the at least one field effect transistor. Alternatively, the control voltage to be output to the field effect transistor can be generated based on the control signals. Furthermore, the control device is preferably set up to process the relevant information in this regard and, in particular, to check the fulfillment of the dissipation condition. Furthermore, the control device is preferably set up to generate and output control commands or the control voltage provided during the rectification carried out by the rectifier. All advantages, features and aspects explained in connection with the method according to the disclosure are equally transferable to the control device according to the disclosure, and vice versa.

In particular, the control device is located at a position different from the rotor. Thus, the control device can be provided on the part of the stator side or on the part of the motor vehicle. Accordingly, a transfer of the control commands or the control voltage from a stationary section, in particular the stator, to the rotor is required. For this purpose, the electric machine can have an inductive communication rotary transformer, which comprises at least one rotor-side communication coil present on the part of the rotor and at least one stator-side communication coil present on the part of the stator, wherein the control commands generated by the control device or the control voltage, which are or is used for the control operation of the rectifier, are or is inductively transferrable from the stator-side communication coil to the rotor-side communication coil. The aspects explained above in connection with the inductive rotary transformer apply generally equally and analogously to the communication rotary transformer.

Furthermore, the present disclosure relates to an electric machine. According to the disclosure, the object is achieved in such a machine in that it comprises a control device, in particular according to the above sections of the description, a stator and a rotor rotatably mounted with respect to the stator and having rotor windings for generating a rotor magnetic field, wherein an active rectifier comprising at least one field effect transistor controllable by way of a control voltage which can be generated on the part of the control device is provided on the part of the rotor, wherein the rectifier electrically connects a voltage source present on the part of the rotor to the rotor windings, and an alternating voltage provided by the voltage source can be converted into a direct voltage by way of the rectifier, wherein the field effect transistor or at least one of the field effect transistors can be brought into an operating state for de-exciting the rotor windings by way of the control voltage, in which the respective field effect transistor forms an ohmic resistance, wherein an energy stored in the rotor windings brings about an electric current flow through the at least one field effect transistor forming the ohmic resistance, so that at least part of this energy is converted into thermal energy. All advantages, features and aspects explained in connection with the method according to the disclosure and the control device according to the disclosure are equally transferable to the electric machine according to the disclosure, and vice versa.

Preferably, the electric machine is connectable to a drive train of the motor vehicle, wherein, in relation to the state connected to the drive train, a traction torque can be generated by way of the electric machine and transferred to the wheels of the motor vehicle via the drive train. For example, an open end of a rotor shaft of the rotor extending along the axis of rotation can be provided, in particular projecting from the housing of the electric machine. This end and a component of the drive train can each have a connecting means, such as a connecting flange, by way of which a mechanical connection, in particular a rotationally fixed mechanical connection, can be established between the shaft and the drive train. The drive train basically comprises all components via which a mechanical coupling can be established between the electric machine and the wheels. Thus, the drive train may comprise drive shafts and/or transmissions, in particular manual and/or differential transmissions and/or clutches.

Finally, the present disclosure relates to a motor vehicle, comprising an electric machine forming a traction motor, in particular according to the above sections of the description, and a control device, in particular according to the above, relevant sections of the description, wherein the electric machine comprises a stator and a rotor rotatably mounted with respect to the stator and having rotor windings for generating a rotor magnetic field, wherein an active rectifier comprising at least one field effect transistor controllable by way of a control voltage, which can be generated on the part of the control device is provided on the part of the rotor, wherein the rectifier electrically connects a voltage source present on the part of the rotor to the rotor windings and an alternating voltage provided by the voltage source can be converted into a direct voltage by way of the rectifier, wherein the field effect transistor or at least one of the field effect transistors can be brought into an operating state for de-exciting the rotor windings by way of the control voltage, in which the respective field effect transistor forms an ohmic resistance, wherein energy stored in the rotor windings brings about an electrical current flow through the at least one field effect transistor forming the ohmic resistance so that at least part of this energy is converted into thermal energy. All advantages, features, and aspects explained in connection with the method according to the disclosure, the control device according to the disclosure, and the electric machine according to the disclosure are equally transferable to the motor vehicle according to the disclosure, and vice versa.

The motor vehicle according to the disclosure preferably comprises an electrical energy storage device in which energy utilizable for the traction of the motor vehicle can be stored. This energy is present in the form of electrical energy and is converted into kinetic energy by the electric machine. Conversely, it is conceivable to operate the electric machine in a recuperation mode, in which kinetic energy of the motor vehicle is converted into electrical energy, which is stored in the energy storage device. A direct voltage can typically be provided by way of the energy storage device, which, in particular, can be a lithium-ion battery. However, an alternating voltage is required for the operation of the electric machine, so that a power electronics unit can be provided on the part of the electric machine, by way of which the direct voltage provided by the energy storage device can be converted into an alternating voltage. The above-mentioned or a further control device can be set up to generate control signals directed toward the operation of the power electronics unit and to output them to the power electronics unit.

The motor vehicle according to the disclosure preferably comprises a cooling system by way of which a cooling fluid can be guided, wherein the cooling section forming a heat sink, which has been already explained above, is integrated into the cooling system. Thus, it can be provided that the cooling system forms a cooling circuit in which the cooling fluid can be conveyed by way of a conveying means. In this embodiment, the cooling fluid circulates from the conveying means to the cooling section and back again and is thus recirculated. The conveying means can be a cooling fluid pump. A cooling device for cooling the cooling fluid, such as a heat exchanger, can be integrated into the cooling system.

### BRIEF DESCRIPTION OF THE SEVERAL VIEWS OF THE DRAWINGS

Further advantages and details of the present disclosure will become apparent from the following exemplary embodiments and from the accompanying figures. In the figures, schematically:

FIG. 1 shows a schematic diagram of a motor vehicle according to the disclosure, shown from the side, according to an exemplary embodiment, comprising an electric machine according to the disclosure according to an exemplary embodiment and a control device according to the disclosure according to an exemplary embodiment,

FIG. 2 shows a highly schematic diagram of the electric machine of the motor vehicle of FIG. 1,

FIG. 3 shows a flowchart of a method according to the disclosure according to an exemplary embodiment, which method is explained with reference to the motor vehicle shown in FIG. 1 and the electric machine shown in FIG. 2,

FIG. 4 shows a section of the schematic diagram of FIG. 2, showing a rectifier during de-excitation of a rotor of the electric machine, and

FIG. 5 shows a coordinate system to illustrate the relationship between the value of a control voltage and the value of an ohmic resistance that occurs in a linear operating state of field effect transistors of the electric machine of FIG. 2 at different temperature values.

### DETAILED DESCRIPTION

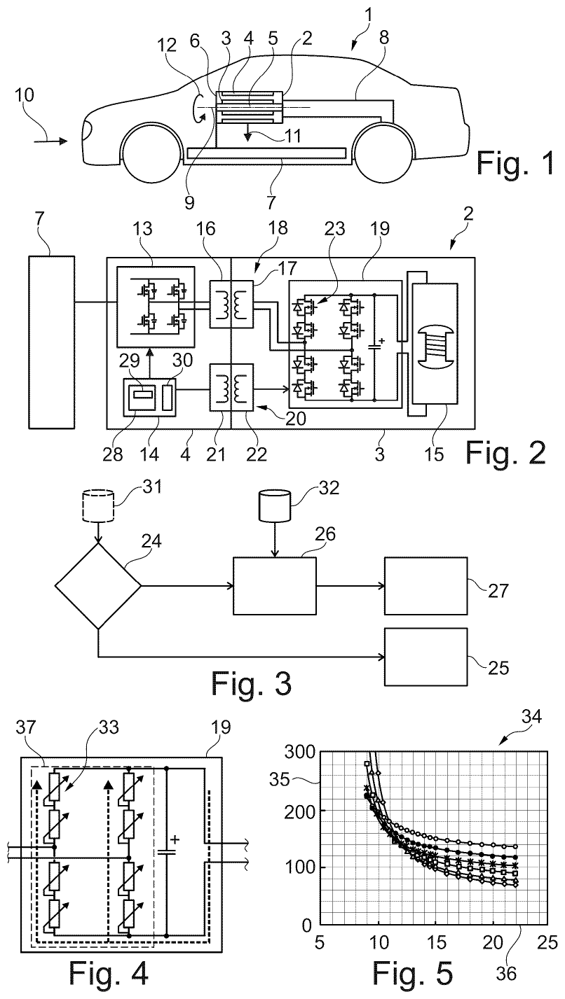

FIG. 1 shows a motor vehicle 1 according to the disclosure according to an exemplary embodiment, comprising an electric machine 2 according to the disclosure according to an exemplary embodiment. Electric machine 2 comprises a rotor 3 and a stator 4. Electric machine 2 is an internal rotor designed as an externally excited synchronous machine. Thus, rotor 3 is arranged in a region of electric machine 2 that is radially further inward than a region in which stator 4 is arranged. A rotor shaft 5 of rotor 3 is rotatably mounted on a housing 6 of electric machine 2, for example by way of a ball or roller bearing.

Electric machine 2 is set up to be operated in a drive mode in which electrical energy stored in an electrical energy storage device 7 of motor vehicle 1 is converted into kinetic energy of motor vehicle 1. A generated drive torque, which is utilized to propel motor vehicle 1, is transferable from electric machine 2 to a drive train 8 of motor vehicle 1. The drive torque is only transferable to the rear wheels, but is additionally or alternatively also transferable to the front wheels. Electric machine 2 can also be operated in a recuperation mode in which kinetic energy of motor vehicle 1 is converted into electrical energy by way of electric machine 2, which can be utilized, for example, to charge electrical energy storage device 7.

Definitions regarding relevant spatial directions are introduced below with reference to electric machine 2. For example, rotor shaft 5 is rotatably mounted about an axis of rotation 9, which extends along a longitudinal direction 10 of electric machine 2. A radial direction 11 extends perpendicular to longitudinal direction 10. A circumferential direction 12 is perpendicular to radial direction 11. This means that a point rotating about axis of rotation 9 moves along circumferential direction 12.

Details regarding electric machine 2 are explained below. FIG. 2 shows a highly schematic view of electric machine 2, which particularly illustrates the division of the components of electric machine 2 into rotor 3 and stator 4. Here, a power electronics unit 13 is provided on the part of stator 4, by way of which a direct voltage provided on the part of electrical energy storage device 7 can be converted into an alternating voltage. For this purpose, a control device 14 according to the disclosure according to an exemplary embodiment is provided, which is set up to generate control signals controlling the operation of power electronics unit 13 or a corresponding control voltage and to output them to power electronics unit 13. Although control device 14 is illustrated here as a component of electric machine 2, it can also be provided outside electric machine 2 and thus be a component of motor vehicle 1 instead. The alternating voltage generated by way of power electronics unit 13 can be used to energize stator windings of stator 4 (not shown in detail in the figures) and the rotor windings 15 of rotor 3, of which only one is indicated schematically in FIG. 2. The stator windings and rotor windings 15, each consisting of a conductor wire, generate magnetic fields due to the electrical energization, i.e., the rotor magnetic field and a stator magnetic field, which interact with each other during the generation of the drive or recuperation torque.

Details regarding the transfer of electrical energy or power from energy storage device 7 to stator windings 15 are explained below. Here, first, the direct voltage provided by energy storage device 7 is converted into an alternating voltage by way of power electronics unit 13. This alternating voltage is transferred to a stator-side field coil 16 present on the part of stator 4, via which field coil 16 energy is transferred inductively to a rotor-side field coil 17 present on the part of rotor 3. Thus, field coils 16, 17 form an inductive rotary transformer 18, via which a contactless energy transfer from stator 4 or a stationary section of electric machine 2 to its rotor 3 is enabled.

Rotor-side field coil 17 implements a voltage source which is present on the part of rotor 3 and on the part of which an electrical alternating voltage is present. This alternating voltage is supplied to a rectifier 19 of rotor 3, which converts this alternating voltage into a direct voltage. Consequently, rectifier 19 connects rotor-side field coil 17 to rotor windings 15, so that the voltage provided via rotor-side field coil 17 and converted into a direct voltage by way of rectifier 19 is supplied to rotor windings 15 for generating the rotor magnetic field. Active rectifier 19 comprises a plurality, namely eight, field effect transistors 23, of which, for the sake of clarity, only one is provided with the corresponding reference numeral in FIG. 2 and which, in this case, are metal oxide semiconductor field effect transistors. The rectification of the alternating voltage provided by rotor-side field coil 17 takes place as a function of the control voltages generated on the part of control device 14, which are each applied to one of field effect transistors 23.

In addition to generating the control signals provided for power electronics unit 13, control device 14 is thus further set up to generate the previously mentioned control signals or control voltages, by way of which the operation of active rectifier 19 is controlled, and to output them to active rectifier 19 via an inductive communication rotary transformer 20. Communication rotary transformer 20 comprises a stator-side communication coil 21 present on the part of stator 4 and a rotor-side communication coil 22 present on the part of rotor 3, wherein the control signals of control device 14 provided for the operation of active rectifier 19 are transferred inductively from stator-side communication coil 21 to rotor-side communication coil 22 and subsequently to field effect transistors 23. The operating principle of communication rotary transformer 20 is generally the same as that of rotary transformer 18.

Normal operation with regard to rectifier 19 is described below, in which the alternating voltage present on rotor-side field coil 17 is converted into a direct voltage by rectifier 19. In this case, rectifier 19 comprises eight field effect transistors 23, which are illustrated as being arranged in four rows and two columns in the schematic diagram shown in FIG. 2. During normal operation, in which rotor windings 15 are excited, the control voltages are generated such that four field effect transistors 23 illustrated in the second and third rows are permanently switched on, with the remaining four field effect transistors 23 operating in pulsed mode.

Reference is made below to FIG. 3, which shows a flow chart of the method according to the disclosure according to an exemplary embodiment which method is explained with reference to motor vehicle 1 of FIG. 1 and electric machine 2 of FIG. 2. The method comprises steps 24-27. The processing and evaluation steps taking place in the context of carrying out the method, as well as the generation of control voltages that takes place in the process, are carried out on the part of control device 14. For this purpose, control device 14 comprises a computer-readable storage medium 28 on which executable instructions 29 are stored which, when executed by a processing device 30 of control device 14, cause control device 14 to carry out the steps provided in the context of the present method.

With respect to first step 24, the initial situation is assumed to be a situation in which rotor windings 15 are to be de-excited. In step 24, control device 14 checks a dissipation condition, the fulfillment of which depends on the presence of a piece of safety information 31. The piece of safety information 31 is only present in certain situations.

Piece of safety information 31 is present, for example, when a state of charge of electrical energy storage device 7, and/or possibly of an intermediate circuit capacitor (not shown in detail) of the electric machine, exceeds a predetermined limit value. The predetermined limit value is chosen such that it is exceeded when electrical energy storage device 7 is fully charged. The corresponding piece of safety information 31 is determined based on a piece of information available in the context of a vehicle control system regarding the current charging status of energy storage device 7, wherein, additionally or alternatively, a determination of the charging status by measurement is also conceivable. Furthermore, piece of safety information 31 is present when an error condition exists on the part of a drive unit, such as power electronics unit 13, of motor vehicle 1. This can be the case if an accident has occurred. In this case, piece of safety information 31 is generated, for example, when a control signal is present that triggers an airbag of motor vehicle 1.

If piece of safety information 31 or a plurality of pieces of safety information 31 is/are present, then the dissipation condition is fulfilled; otherwise, the method continues with next step 25. If the dissipation condition is not fulfilled, rotor windings 15 are de-excited as explained below. In this regard, it is relevant that not only a conversion of the alternating voltage present on the part of rotor-side field coil 17 into a direct voltage present on the part of rotor windings 15 can be carried out by way of rectifier 19, but also the reverse conversion, thereby enabling bidirectional energy transfer by way of rotary transformer 18. In the context of de-excitation taking place in step 25, the control voltages are generated by control device 14 and output to field effect transistors 23 in such a way that the direct voltage present on the part of rotor windings 15 is converted into an alternating voltage, which in turn brings about an inductive energy transfer from rotor-side field coil 17 to stator-side field coil 16. Referring to FIG. 2, the four field effect transistors 23 illustrated in the first and fourth rows are switched on, with the remaining four field effect transistors 23 operating in pulsed mode.

The case in which fulfillment of the dissipation condition was determined in the context of step 24, i.e., in which at least one piece of safety information 31 is present, is explained below. In this case, the method continues with steps 26 and 27, with step 26 being performed cyclically in parallel with step 27. Here, in step 26, piece of temperature information 32 relating to the current temperature of field effect transistor 23 is determined. For this purpose, a temperature sensor (not shown in detail in the figures) arranged in the region of rectifier 19 is provided. In the context of data merging, piece of temperature information 32 is determined using a model and a lookup table, which is stored, for example, on the part of control device 14. By way of the model, dependencies of physical or electrical quantities for field effect transistors 23 are determined according to their specific structural designs, and the results are also used in the context of the lookup table.

In step 27, the control voltages are generated on the part of control device 14 in such a way that field effect transistors 23 are brought into a linear operating state in which each of field effect transistors 23 forms an ohmic resistance 33. This state is indicated by FIG. 4, which shows rectifier 19, with field effect transistors 23 being indicated as voltage-dependently controllable resistances. In FIG. 4, for the sake of clarity, only one of resistances 33 shown is provided with a corresponding reference numeral. In this case, the value of respective resistance 33 depends on the respective control voltage. Because field effect transistors 23 each form a resistance 33, a power loss occurring at resistances 33 causes field effect transistors 23 to heat up, which ultimately results in the de-excitation of rotor coils 15. The current flow through field effect transistors 23 and resistances 33 that occurs in this case is indicated in FIG. 4 by a dashed line.

The generation of the control voltages on the part of control device 14 takes place in such a way that respective field effect transistor 23 forms an ohmic resistance 33 with a specifically predetermined resistance value. For this purpose, piece of temperature information 32 already mentioned is taken into account. Here, FIG. 5 shows a coordinate system 34 relating to the relationship between the resistance value of ohmic resistance 33 in milliohms, which is plotted along ordinate axis 35, and the value of the respective control voltage in volts, which in this case forms a gate-source voltage and is plotted along abscissa axis 36. A plurality of curves are illustrated, each associated with a value of a temperature prevailing at field effect transistor 23. Here, the line comprising open circles represents a temperature of 150° C., the line comprising filled circles a temperature of 125° C., the line comprising star symbols a temperature of 100° C., the line comprising square symbols a temperature of 75° C., the line comprising triangular symbols a temperature of 50° C., and the line comprising diamond symbols a temperature of 25° C. As can be seen, the resistance value decreases with increasing value of the control voltage at constant temperature. In the linear operating state, which relates to the left-hand, steep sections of the curves shown in FIG. 5, there is an extremely strong temperature dependence with respect to the resistance value at constant gate-source voltage. Here, the resistance values decrease with increasing temperatures, which in turn leads to a higher current flow through field effect transistor 23, which in turn results in a further increase in temperature. Without countermeasures, this vicious circle could result in the burn-out and thus the destruction of field effect transistor 23. To address this, piece of temperature information 32 is continuously and cyclically determined in step 26, with the control voltage being reduced accordingly in the event of an increasing temperature in order to increase the resistance value accordingly and to reduce the current flow and thus the temperature rise.

Due to the ensuing dissipation of the energy present on the part of rotor windings 15 by way of ohmic resistances 33, heat is generated in the region of rectifier 19. The same generally applies to normal operation of rectifier 19. This heat generation necessitates targeted cooling in the region of rectifier 19, with details in this regard being explained below. Here, motor vehicle 1 comprises a cooling system (not shown in detail in the figures) which forms a cooling circuit in which a cooling fluid circulates. To cool the cooling fluid, the cooling system further comprises a cooling device, specifically a heat exchanger.

Rectifier 19 is arranged in a cooling section 37 of rotor 3, which forms a heat sink and is integrated into cooling system 23 and through which the cooling fluid flows. Cooling section 37 is indicated by dashed lines in FIG. 3. The cooling fluid passes from the conveying means into cooling channels of cooling section 37 (not shown in detail in the figures), and from there to the cooling device and then back to the conveying means. The cooling channels running through cooling section 37 are arranged directly beneath rectifier 19. The thickness of the material of rotor 3 remaining between the cooling channels and rectifier 19, which in this case is a metal, is as small as possible to enable the most effective heat transfer from rectifier 19 to the cooling fluid, and is preferably only a few millimeters.

In the cooling channels, deflection structures are provided on a channel wall delimiting the cooling channel, by way of which the cooling fluid flowing through the cooling channel can be deflected and swirled. This enables a more efficient transfer of heat from rectifier 19 to the cooling fluid. The deflection structure comprises a plurality of web-like, elongated structures arranged one after the other perpendicular to the flow direction, which can also be referred to as cooling fins or cooling ribs.

German patent application no. 102024124569.7, filed Aug. 28, 2024, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for de-exciting rotor windings of a rotor of an electric machine for a motor vehicle, wherein the electric machine includes a stator and the rotor rotatably mounted with respect to the stator and having the rotor windings for generating a rotor magnetic field, wherein an active rectifier including at least one field effect transistor controllable by way of a control voltage is provided on a part of the rotor, the method comprising:
electrically connecting, by the active rectifier, a voltage source present on the part of the rotor to the rotor windings;
converting, by the active rectifier, an alternating voltage provided by the voltage source into a direct voltage;
bringing, by way of the control voltage, the at least one field effect transistor into an operating state that de-excites the rotor windings, in which the at least one field effect transistor forms an ohmic resistance; and
flowing, based on the energy stored in the rotor windings, an electrical current through the at least one field effect transistor forming the ohmic resistance, at least part of the energy stored in the rotor windings being converted into thermal energy.

2. The method according to claim 1, wherein the at least one field effect transistor is a metal oxide semiconductor field effect transistor.

3. The method according to claim 2, wherein the ohmic resistance has a predetermined resistance value.

4. The method according to claim 3, wherein a temperature dependence of the predetermined resistance value is taken into account when bringing the at least one field effect transistor into the operating state that de-excites the rotor windings, in which the at least one field effect transistor forms the ohmic resistance having the predetermined resistance value.

5. The method according to claim 4, wherein the temperature dependence is taken into account by determining a current temperature of the at least one field effect transistor.

6. The method according to claim 1, wherein the at least one field effect transistor is arranged on or in a cooling section of the rotor that forms a heat sink.

7. The method according to claim 6, wherein the cooling section has at least one cooling channel through which a cooling fluid flows.

8. The method according to claim 1, wherein the electric machine has an inductive rotary transformer including at least one rotor-side field coil present on the part of the rotor and forms the voltage source, and at least one stator-side field coil present on a part of the stator, and wherein electrical energy is transferred inductively from the at least one stator-side field coil to the at least one rotor-side field coil.

9. The method according to claim 8, wherein, as an alternative to de-excitation of the rotor windings by way of the rectifier, a direct voltage present on the part of the rotor windings is converted into an alternating voltage, and wherein the energy stored in the rotor windings is transferred inductively from the at least one rotor-side field coil to the at least one stator-side field coil.

10. The method according to claim 9, further comprising:
checking for fulfillment of a dissipation condition, wherein the dissipation condition is fulfilled if at least one piece of safety information is present which indicates a presence of an operating state of the electric machine and/or the motor vehicle in which transferring the energy from the at least one rotor-side field coil to the at least one stator-side field coil is disadvantageous, wherein, if the dissipation condition is not fulfilled, the de-excitation of the rotor windings takes place by way of a transfer of the energy stored in the rotor windings from the at least one rotor-side field coil to the at least one stator-side field coil and, if the dissipation condition is fulfilled, the de-excitation of the rotor windings takes place by way of converting the energy stored in the rotor windings into thermal energy by the at least one field effect transistor forming the ohmic resistance.

11. The method according to claim 10, wherein the piece of safety information indicates that a state of charge of an electrical energy storage device of the motor vehicle, which provides electrical energy for operating the electric machine, exceeds a predetermined limit value.

12. The method according to claim 10, wherein the piece of safety information indicates that an error condition exists on part of a drive unit of the motor vehicle.

13. A control device for de-exciting rotor windings of a rotor of an electric machine for a motor vehicle, wherein the electric machine includes a stator and the rotor rotatably mounted with respect to the stator and having the rotor windings for generating a rotor magnetic field, wherein an active rectifier including at least one field effect transistor controllable by way of a control voltage is provided on a part of the rotor, wherein the active rectifier electrically connects a voltage source present on the part of the rotor to the rotor windings and an alternating voltage provided by the voltage source is converted into a direct voltage by way of the active rectifier, the control device comprising:
a processing device; and
a computer-readable storage medium storing executable instructions that, when executed by the processing device, cause the control device to:
output the control voltage to the at least one field effect transistor, wherein the control voltage brings the at least one field effect transistor into an operating state that de-excites the rotor windings, in which the at least one field effect transistor forms an ohmic resistance, and wherein, based on the energy stored in the rotor windings, an electrical current flows through the at least one field effect transistor forming the ohmic resistance and at least part of the energy stored in the rotor windings is converted into thermal energy.

14. An electric machine, comprising:
a control device;
a stator;
a rotor rotatably mounted with respect to the stator and having rotor windings that, in operation, generate a rotor magnetic field; and
an active rectifier including at least one field effect transistor controllable by way of a control voltage generated by the control device is provided on a part of the rotor,
wherein the active rectifier, in operation, electrically connects a voltage source present on the part of the rotor to the rotor windings, and
wherein an alternating voltage provided by the voltage source, in operation, is converted into a direct voltage by way of the active rectifier,
wherein, by way of the control voltage, the at least one field effect transistor, in operation, is brought into an operating state that de-excites the rotor windings, in which the at least one field effect transistor forms an ohmic resistance, and
wherein an energy stored in the rotor windings brings about an electrical current flow through the at least one field effect transistor forming the ohmic resistance, and at least part of the energy stored in the rotor windings is converted into thermal energy.

15. A motor vehicle, comprising:
the electric machine according to claim 14.
